(19) United States
(12) Patent Application Publication
(10) Pub. No.: US 2005/0052161 A1
(43) Pub. Date: Mar. 10, 2005

(54) Instant charge battery

(76) Inventor: David Franklin Scamard, Tampa, FL (US)

Correspondence Address: Dr. David F. Scamard, O.D., 18106 Princess Point Circle, Tampa, FL, 33647, US

(21) Appl. No.: 10/657,263

(22) Filed: Sep. 8, 2003

(51) Int. Cl. H02J 1/00

(52) U.S. Cl. 320/166

(57) ABSTRACT

The Instant Charge Battery is an energy storage and delivery device comprising of a capacitor instantaneously capturing sufficient electrical energy from an energy source for the purpose of charging a rechargeable battery, a charge circuit which transfers and regulates a charge current and a charge voltage from the capacitor to the battery, and a chargeable battery. The chargeable battery can be of any chargeable/rechargeable cell(s) such as, but not limited to, NiCad, NiMH or Lithium-ion.

### U.S. PATENT DOCUMENTS

| | | | |
|---|---|---|---|
| 3288641 | November 1966 | Rightmire | 361/434. |
| 3423642 | January 1969 | Plehal et al. | 361/434. |
| 3538394 | November 1970 | Bourgault et al. | 361/434. |
| 4830938 | May 1989 | McCullough et al. | 429/210. |
| 4900643 | February 1990 | Eskra et al. | 429/210. |
| 5147739 | September 1992 | Beard | 429/194. |
| 5200690 | April 1993 | Uchida | 320/106. |
| 5439756 | August 1995 | Anani et al. | 429/9. |
| 5871859 | February 1999 | Parise | 429/7. |
| 6057050 | May 2000 | Parise | 429/7. |
| 6445936 | September 2002 | Cannon et al. | 455/573. |
| 6476584 | November 2002 | Sakakibara | 320/150. |

Foreign Patent Documents

| | | | |
|---|---|---|---|
| 59-14681 | January 1984 | JP | 429/9. |
| 1-03127 | April 1989 | JP | 320/20. |
| 1-920226 | July 1989 | JP | 320/20. |

### BACKGROUND OF THE INVENTION

1. Field of the Invention

The present invention relates in general to the field of electrical energy storage and delivery devices. In particular, the present invention relates to an instant charge battery and method of charging and discharging same.

2. Prior Art

The two most common electrical energy storage and delivery devices are batteries and capacitors. Batteries prove to be more practical of the two in the majority of applications of portable electric devices due to the fact that they are able to deliver a relatively constant voltage over an extended period of time. With the increase in popularity and dependency on portable electric devices, chargeable batteries are not only practical, but economical as well. The charging time of chargeable batteries varies greatly—anywhere from approximately an hour to several hours, depending upon the size and type of chargeable battery. This charging time contrasts starkly to the charging time for capacitors—which can charge in a matter of seconds. Although capacitors have the advantage of charging quickly, they have the disadvantage of being unable to deliver a constant voltage over a sustained period of time. To achieve the desirable qualities of both, batteries and capacitors can be combined for specific applications.

Battery/capacitor combinations are well known in the art. The most common application of this combination is in the photo flash. In this battery/capacitor combination, a battery is used to charge a capacitor for the purpose of providing a high intensity burst of electricity to flash the strobe of the camera. Another application of the battery/capacitor combination is in portable radio transmitter/receivers. In this combination, the battery provides a constant level of power during the receiving/standby mode. In the transmission mode, however, the radio requires a burst of power to transmit the signal. The capacitor provides that burst of supplemental power during radio transmission. In both of these applications, the battery is used to charge the capacitor which, in turn, is used to provide energy for the use of an electrical device.

However, there is no prior art of battery/capacitor combinations where the capacitor provides a charging current to the battery. There certainly exists the need for battery/capacitor hybrids combining the quick charge qualities of capacitors with the constant level and extended delivery of electrical energy qualities that batteries posses.

### SUMMARY OF THE INVENTION

The present invention solves the drawbacks of long charging times for chargeable batteries by utilizing a capacitor or series of capacitors to quickly capture electrical energy—which, in turn, is transferred to a chargeable battery. The capacitor(s) should be of the type to discharge the stored energy over the longest period of time possible—not instantaneously. The prolonged transfer of energy from the capacitor to the battery enables the battery to charge more efficiently. The transfer of the electrical energy from the capacitor(s) to the battery is regulated by the charge circuit. The charge circuit optimizes the amount as well as the rate of transfer of electrical energy from the capacitor(s) to the battery.

The Instant Charge Battery will prove to be useful in a wide range of applications. It will be especially effective in low power consumption portable electronic devices such as, but not limited to, cell phones, PDA's, MP3 players, digital cameras and notebook computers.

In one embodiment of the invention, a single capacitor is utilized for the capacitor portion of the Instant Charge Battery apparatus.

In another embodiment of the invention, multiple capacitors comprise the capacitor portion. The size and number of capacitors required for the capacitor portion is determined by the amount of electrical energy required to charge the battery portion.

In another embodiment of the invention, the capacitor portion only provides a partial charge to the chargeable battery portion. This embodiment would be an important feature of an electronic device for use in emergency situations.

In yet another embodiment of the invention, the capacitor and charge circuit portions are integrated into the electrical device, such that the battery portion is separate and replaceable.

### BRIEF DESCRIPTION OF THE DRAWINGS

FIG. 1 is a schematic block diagram of an electrical energy storage device in accordance with one embodiment of the present invention.

### DETAILED DESCRIPTION OF THE PREFERRED EMBODIMENTS

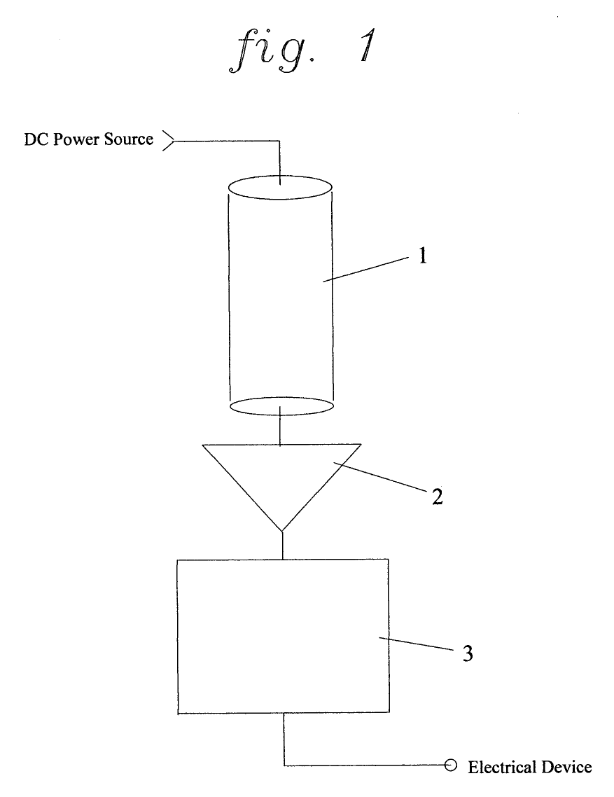

FIG. 1 is a block diagram illustrating the schematic structure of the instant charge battery apparatus according to one embodiment of this invention.

The DC power source provides the electrical energy necessary to charge the capacitor portion 1 of the Instant Charge Battery apparatus. It can be in the form of an AC transformer such as to convert household AC electricity into the appropriate DC voltage and current for the charging of the capacitor portion 1. The DC power source can also be in the form of a DC adaptor (such as a car adaptor) so as to convert a DC voltage and current (such as from an automobile power outlet) into the appropriate DC voltage and current for the charging of the capacitor portion 1. The AC/DC converter and/or DC adaptor may be either internal or external to the electrical device utilizing the Instant Charge Battery apparatus.

Capacitor portion 1 comprises singular or multiple capacitors for instantly capturing electrical energy from the DC power source. This captured electrical energy is then transferred to the chargeable battery portion 3 via the charge circuit portion 2. The charge circuit portion 2 regulates the charging of the chargeable battery portion 3 from the capacitor portion 1.

The multiple capacitor configuration of the capacitor portion 1 would allow for a more effective charging of the chargeable battery portion 3 by sustaining the charging current to the chargeable battery 3 over a longer period of time. This prolonged charging time is accomplished as each capacitor transfers its electrical energy in series or parallel. Conceivably, sequential transfer would be the most effective.

The chargeable battery portion 3 can be of any chargeable/rechargeable battery cell(s) such as, but not limited to, NiCad, NiMH or Lithium-ion. The chargeable battery portion 3 may consist of either singular or multiple chargeable battery cells.

The electrical device can be any instrument or equipment that requires electrical energy in order to operate. The present invention would be exceptionally useful for portable electronic devices such as cell phones, PDA's, notebook/laptop computers, MP3 players, digital cameras, radios, etc.—especially with the advent of low power consumption technology for these types of devices.

It is noted that the embodiments of the Instant Charge Battery apparatus described herein in detail for exemplary purposes are, of course, subject to many different variations in structure, design, application and methodology. Due to the many varying and different embodiments that may be made within the scope of the inventive concept(s) herein taught, and due to the many modifications that may be made in the embodiments herein detailed in accordance with the descriptive requirements of the law, it is to be understood that the details herein are to be interpreted as illustrative and not in a limiting sense whatsoever.

1. An energy storage and delivery device comprising:
a capacitor portion consisting of singular or multiple capacitors for instantaneously capturing electrical energy from a power source for the purpose of charging the battery portion,
a charge circuit portion which transfers and regulates a charge current and a charge voltage from the capacitor portion to the battery portion,
and a chargeable battery portion—which can be of any chargeable/rechargeable battery cell(s) such as, but not limited to, NiCad, NiMH or Lithium-ion.

2. The energy storage and delivery device, according to claim 1, wherein the capacitor portion, when the unit is connected to an electrical source, captures an electric charge over a short period of time for the purpose of charging the chargeable battery portion;
the capacitor portion, when fully charged, transfers its electrical energy to the battery portion over an optimal period of time and at an optimal current throughout the various stages of the battery charging process;
this transfer and regulation of the charging current from the capacitor portion to the battery portion is accomplished via the charge circuit portion.

3. The energy storage and delivery device, according to claim 2, wherein the charge circuit portion detects when the capacitor portion is fully charged in order to begin the charging process of the battery portion;
the charge circuit portion also detects the amount of electric current required to optimally charge the battery portion—and varies the charging current from the capacitor portion to the battery portion accordingly;
as the battery portion is being charged, the charge circuit portion is also able to detect when the electric device is in use, and therefore transfer additional electric current for the operation of the device.
